(19) United States
(12) Patent Application Publication
(10) Pub. No.: US 2013/0020780 A1
(43) Pub. Date: Jan. 24, 2013

(54) Linear Drive Regular Upright Cycle

(71) Applicant: Chung-Chiao John Po, (US)

(72) Inventor: Chung-Chiao John Po, (US)

(21) Appl. No.: 13/189,488

(22) Filed: Jul. 23, 2011

(51) Int. Cl. B62M 1/04

(52) U.S. Cl. 280/252

(57) ABSTRACT

A linear drive regular upright cycle (10) having linearly reciprocating pedals (30a,b) located between front wheel (14) and rear wheel (16) in order to achieve a more popular linear drive bicycle design, in upright bicycle with regular handling characteristics. Top extremities of a pair of pedal-sliders (24a,b) are journalled for independent up and down type oscillation in a pedal-slider bracket (26) which is connected to a frame (12) through a seat tube (28). Linearly reciprocating pedals (30a,b) are attached to lower extremities of pedal-sliders (24a,b) and are rotatably linked to crank (32) through a pair of straight links (36a,b); so as to transfer power from pedals (30a,b) to crank (32). Links especially are super short and straight whereby saving weight, while other dimensions are mostly halved. Axis of reciprocating movement of pedal-sliders (24a,b) crosses to front of axis of crank (32) giving it an inherent tendency to rotate forward whereby eliminating “dead-spot”.

### BACKGROUND

1. Field of Invention

This invention relates to cycles in general, such as bicycles, tricycles, etc. More specifically, this invention relates to regular bicycle like in road, cyclocross, mountain, or BMX-types, that uses linear drive to convert circular pedaling motion of regular crank to a linearly reciprocating pedaling motion; that is aligned in vertical, or up and down, and with pedals placement above and to the front of the bottom bracket. In order to simplify by reduce bulk and mass, plus improve handling inherit in regular upright bicycle. Even more specifically, this invention relates to regular bicycle with asymmetrical (off-center or not-symmetrical) linear drive; that eliminates dead-spot, or top and bottom dead centers, in linearly reciprocating system, unto a highly smooth operating linear drive regular upright bicycle.

2. Description of Prior Art

Heretofore, linear drive recumbent bicycles are known in prior art, and one specific embodiment of this type of drive system is disclose in U.S. Pat. No. 5,290,054 (C. J. Po, March 1994). As is clear from prior art, it is desirable to build a linear drive recumbent bicycle with linear reciprocating pedaling motion. However, it is even more desirable to build a linear drive regular bicycle for benefit of the masses; with even more weight savings, substantially better, and greater comforts. To achieve weight savings, overall dimensions of the linear drive component structure is effective halved; handling is improved by more relaxed foot placement than that afforded by regular bicycle crank, and greater comfort is achieved with better support for rider at front narrow portion of the saddle. So this invention modernizes the structure of my previous invention, which is strictly designed for recumbent bicycles, and brought it more in line with demands for regular bicycles.

As seen on all figures, linear drive designed strictly for recumbent bicycle has inherent structural differences, as compared to linear drive made specifically for regular bicycles, therefore have many disadvantages. Most prominent of these is placement of pedals at the furthest point from the crank, below the seat; which led to ultra lengthy link, as between the pedals and the crank, unto noticeable weight and cost penalties. To the contrary, the advantages of this invention have shorter pedal-sliders (same as crank-arms but oscillating), plus much shorter links also, unto greatest weight reductions critical in racing. Therefore prior art of above two paragraphs have structures that are practical only for recumbents, therefore not applicable to regular upright bicycles. Accordingly, further objects and advantages will become apparent from a consideration of the detailed drawings and ensuing descriptions of it.

### DRAWING FIGURES

FIG. 1 is an elevational view of the preferred embodiment of a linear drive regular upright bicycle according to my invention with certain portions of such bicycle being omitted for the sake of clarity.

FIG. 2 is a perspective view of the linear drive regular bicycle of FIG. 1.

FIG. 3 is a fragmentary perspective view of the linear drive mechanism of the bicycle in FIG. 2. In addition, an animation view of the mechanism of the bicycle in FIG. 3 is presented to further clarify; in the form of a series of calculator screenshots (from TI-89—Texas Instrument calculator).

### DESCRIPTION

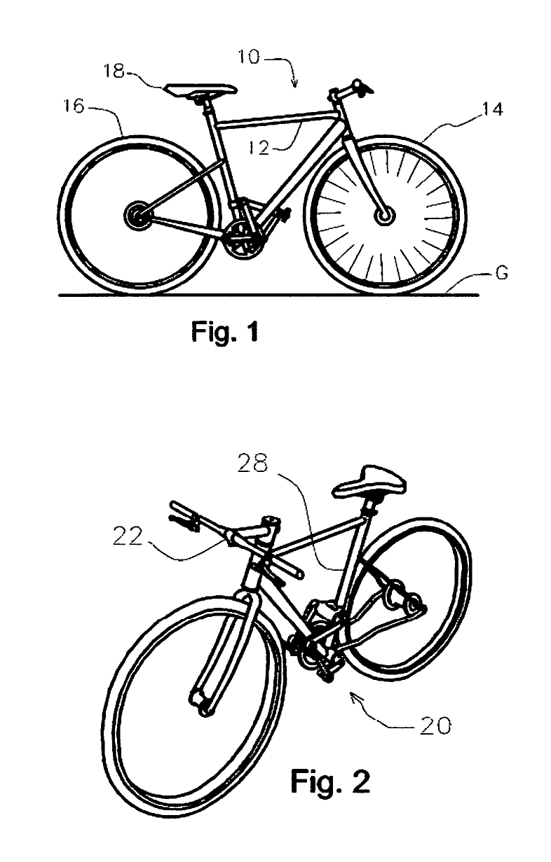

### FIG. 1

A linear drive regular upright cycle according to the preferred embodiment of my invention is identified generally by reference numeral 10. Please note that from now on my invention will simply be referred to as bicycle 10. The bicycle 10, as shown in FIG. 1 in an upright rest position on ground G, is a regular or conventional bicycle as seen on the typical public road; thereby includes a frame 12 of regular diamond-shaped frame-type, supported by a front wheel 14, a rear wheel 16, and a seat 18 of regular shape and size. And including a multiplicity of other components and parts essential to functionality of the everyday bicycle.

### FIG. 2

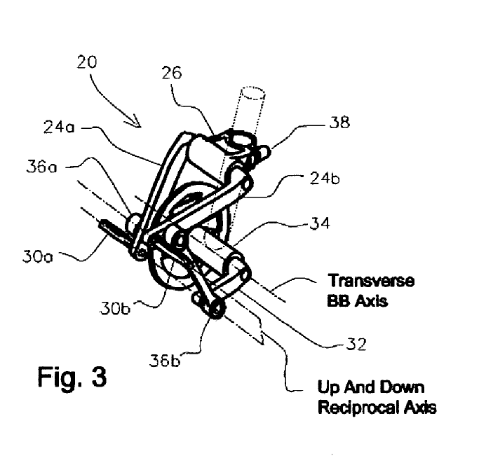

A linear drive mechanism is identified generally by reference numeral 20. Please note that from now on linear drive will simply be referred to as mechanism 20, and will be fully described in FIG. 3. A handlebar 22 can accommodate a multiplicity of commonly available accessories or clip-ons, for two or three differing positions optimized for normal, enhanced handling required for time trialing, or in off-road uses. Frame 12 comprises a straight seat tube 28, which is located in the mid-section thereof.

### FIG. 3

Mechanism 20 is provided with a straight right pedal-slider 24a, and a straight left pedal-slider 24b; and their upper ends are journalled, from a pedal-slider bracket 26; as to effect an up and down type oscillation of a linear pedaling motion. Bracket 26 is slidingly attached to tube 28 (in dotted lines), and consists of two half-length spindles; conjoined in such a way as to allow for their free and independent oscillation. A right pedal 30a, and a left pedal 30b are attached one at each of the two lower ends of pedal-sliders 24a and 24b respectively. Also provided is a regular rotary crank 32, which is journalled for full 360-degree rotation, in a bottom bracket 34 of mechanism 20. Further, pedals 30a is also rotatably attached to one of the extremities of crank 32 through a generally straight right link 36a, for transmission of power from the pedal to the crank. Similarly, pedal 30b is also rotatably attached to the other extremity of crank 32, through a generally straight left link 36b. Links 36a and 36b are generally straight because they do not interfere with the higher amplitudes of front wheel steering movement. Links 36a and 36b of my invention are also shorter than those in prior art, and bracket 26 is positioned at a set distance from bracket 34. So that the pedals' linear reciprocal motion axis (indicated by vertical center line, that connects at right angle with two pedals' center lines) crosses ahead of the crank's transverse axis (horizontal center line), at an set angle or predetermined alignment. Additional structures, whose reference numerals have been omitted for the sake of clarity, include provisions for front steering head, front drive chain rings, chains, with corresponding rear driven cogs; and further, in seat post, seat stay, chain stay that make up rear triangular portion of frame 12, with front triangular portion of other tubular made up, etc.

### OPERATION OF INVENTION

### TI-89

Linear drive mechanism 20 with a vertical pedaling axis (of linear reciprocal motion) that swings across to the front of crank's transverse axis has an unobvious advantage. Linear drive mechanism 20 is slightly more complex thereby requiring aid of animation technique, that allows design data to be pre-checked; as with “Sketchpad” application (TI-App) expressed below in continuous screenshots.

Some of abbreviated letter designations are linear drive (LD), for regular (rg) bikes, scale 1:20 (Sc), length of linear pedal-arms (L:Arm); or distance between two opposing pedals (D:Ped), which is not so critical or just for reference; radius of rotary crank (R:Crn), length of connecting rod or link (L:Rod), distance between top (pedal-slider) and bottom bracket (D:T-B), diameter of wheel (Dia-Wh) which is referenced as 700 mm or 27″, and asymmetric angle (<Asy). Below that are start/stop (A/M) animation or action buttons, that is in one partially blocked by a cursor-hand; and then last line are length adjustment for L:Rod and R:Crn, to try out other or variant dimensions. By principle of parallax, objects that are closer to viewer are displayed with thick lines, and vice versa for the rest.

The advantage of mechanism 20 of my invention is the virtual elimination of crank kick backs, and crank getting stuck during use; or the crank's top and bottom dead centers as associated with other drive mechanisms, that are purely symmetrical in alignment, are bypassed.

### CONCLUSION, RAMIFICATIONS AND SCOPE OF INVENTION

Thus the reader will see that my invention provide a truly compact and smooth operating linear drive regular bicycle.

While my above description contain many specificities, these should not be construed as limitations on the scope of the invention, but rather as an exemplification of a few embodiments thereof. Examples of other variations may be an addition of quick release to clamping device that secures the bracket 26 to seat tube.

Aforementioned quick release can be featured with a keyed lock, as to constitute a locking clamp 38 for bracket 26; so that bracket 26 can be fixed at certain height from bracket 34, as to reduce mechanism 20 operability thereby better secure itself along with the bicycle. Another example of mechanism 20 with both pedals positioned ahead of bottom bracket is as an add-on to existing rear suspension; that can produce a damping or squatting effect under sudden braking or loading of front suspension; said rear suspension should be tubular with equivalent of lower seat tube section, whereby mechanism 20 in bracket 26 can be properly attached.

Accordingly, the scope of the invention should be determined not by the embodiments illustrated, but by the appended claims and their legal equivalents.

I claim:

1. A linear drive regular upright cycle comprising:
a front wheel;
a rear wheel;
a frame extending between said front and rear wheel to enable said frame to roll along a surface, said frame also comprising a steering head; said front wheel being journalled in said steering head for oscillation about a generally vertically extending axis so as to allow steering of said cycle;
a plurality of generally straight pedal-slider means being journalled in pedal-slider bracket means for up and down type oscillation about a generally vertical axis, said pedal-slider bracket means being attached to said frame so as to support said pedal-slider means;
a crank being journalled in said frame for full 360-degree rotation about a generally horizontal extending axis;
a plurality of pedals attached to said pedal-slider means, said pedals travel along a linear motion axis; said pedal-slider means journalled in said frame at an upper end which is shifted a distance away from said crank so that said linear motion axis of said pedals crosses in front of axis said crank;
a plurality of generally straight link means for linking said pedals with said crank to enable transmission of power from said pedals to said crank.

2. The cycle of claim 1 wherein said crank further comprising means necessary to transmission of said power from said crank to said rear wheel.

3. The cycle of claim 1 wherein said frame also comprising generally tubular sections that make up a common diamond shape rigidly configured frame.

4. The cycle of claim 3 further including a handlebar assembly journalled in said steering head, as to allow steering of said cycle.

5. The cycle of claim 4 further including a seat spaced from said pedals, said seat being supported on a seat tube, so that height of said seat can be fixed; said pedal-slider bracket means is slidingly secured to said seat tube, whereby at certain distance away from said crank said pedal-slider means is operable, while at a certain distance other than said distance said pedal-slider means becomes inoperable.

6. The cycle of claim 5 wherein said pedal-slider means further including a locking clamp with a keyed lock, whereby rendering pedal-slider means inoperable by function of said locking clamp.
